(19) United States
(12) Patent Application Publication
(10) Pub. No.: US 2012/0054042 A1
(43) Pub. Date: Mar. 1, 2012

(54) ID-VALUE ASSESSMENT DEVICE, ID-VALUE ASSESSMENT SYSTEM, AND ID-VALUE ASSESSMENT METHOD

(75) Inventors: Yohei KAWAMOTO, Tokyo (JP); Tomoyuki Asano, Kanagawa (JP); Seiichi Matsuda, Tokyo (JP); Masakazu Ukita, Kanagawa (JP); Masanobu Katagi, Kanagawa (JP); Yu Tanaka, Tokyo (JP); Shiho Moriai, Kanagawa (JP)

(73) Assignee: SONY CORPORATION, Tokyo (JP)

(21) Appl. No.: 13/182,854

(22) Filed: Jul. 14, 2011

(30) Foreign Application Priority Data
Aug. 25, 2010 (JP) 2010-188127

(51) Int. Cl. G06Q 30/00; G06F 15/18; G06N 5/00

(52) U.S. Cl. 705/14.69; 706/45; 706/12

(57) ABSTRACT

An ID-value assessment device includes: an assessment calculation section that calculates a value assessment of a user to be assessed by using an assessment function of outputting the value assessment, which represents values of the corresponding user, in response to inputs of user attribute information representing an attribute of the user and service attribute information representing an attribute of a service and general information; and an assessment output section that outputs a user ID of the user to be assessed and the value assessment of the corresponding user, which is calculated by the assessment calculation section, in association with each other.

### BACKGROUND

The present disclosure relates to an ID-value assessment device, an ID-value assessment system, and an ID-value assessment method.

In most websites, advertisements of various products and services are inserted in the form of a banner advertisement or the like. The fee for the publisher of the advertisement may be determined on the basis of how many times the banner advertisement is clicked, or may be determined on the basis of sales of the product or the service. The former method, in which the fee is determined on the basis of presence/absence of the click operation, is called a pay-per-click method. Further, the latter method, in which the fee is determined at a certain rate to sales, is called a fixed-rate payment method. Otherwise, there is also a flat-rate payment method in which the fee is determined at a certain price.

Regarding the pay-per-click method, Japanese Patent No. 4217998 discloses a method of counting the number of accesses to the advertiser through the banner advertisement and charging the fee depending on the number of accesses to the advertiser. Further, Japanese Unexamined Patent Application Publication No. 2003-108875 also discloses a method of determining the fee depending on the click operation. On the other hand, regarding the fixed-rate payment method, for example, Japanese Patent No. 3440040 discloses a method of determining the fee depending on purchase performance of the product purchased by a user.

### SUMMARY

However, in the case of the pay-per-click method, it is difficult to pay the fee correctly which depends on the purchase action of a user with regard to the publisher of the advertisement. Further, even when the advertisement is clicked for the sake of abusively obtaining the fee, the fee is only paid corresponding to the number of clicks. On the other hand, in the case of the fixed-rate payment method, until a product or a service is actually purchased, the fee is not paid to the publisher of the advertisement. Further, in the case of the flat-rate payment method, the fee is determined regardless of the effect of the advertisement.

As described above, the payment methods in the related art do not determine the fee by sufficiently assessing the effect of the insertion of the advertisement. In particular, in the payment method used in the related art, there is no idea of determining the fee in terms of which user views which product advertisement or which service advertisement and how much the effect of sales promotion is brought about when the user views the advertisement.

For example, when a user interested in cosmetics clicks a banner advertisement for a cosmetic, it can be considered that the user is highly likely to purchase the product of the advertisement. Further, when the user is a female and the site with the banner advertisement relates to beauty treatments, the banner advertisement for the cosmetic is highly likely to be clicked. Hence, the user, who is interested in cosmetics, is valuable to the advertiser of the cosmetic, and thus the advertiser may prefer the user to click the banner advertisement. It is apparent that the advertiser of the cosmetic wants to pay a higher fee to the advertisement publisher of a site which is likely to mostly attract users interested in the cosmetic, and wants to pay a lower fee to the advertisement publisher of a site which is likely to attract only users not interested in cosmetics.

The methods of determining the fee paid to the publisher of the advertisement are exemplified, but the assessment of the values of users based on the relationship between users and services may be applicable to various fields. Accordingly, the disclosure has been made in view of the above problems, where it is desirable to provide a new and upgraded ID-value assessment device, an ID-value assessment system, and an ID-value assessment method capable of assessing the values of users on the basis of the relationships between users and services.

According to an embodiment of the disclosure, there is provided an ID-value assessment device including: an assessment calculation section that calculates a value assessment of a user to be assessed by using an assessment function of outputting the value assessment, which represents the values of the corresponding user, in response to inputs of user attribute information representing an attribute of the user and service attribute information representing an attribute of a service and general information; and an assessment output section that outputs a user ID of the user to be assessed and the value assessment of the corresponding user, which is calculated by the assessment calculation section, in association with each other.

Further, it is preferable that the ID-value assessment device should further include an assessment function generation section that generates the assessment function through machine learning based on a set of user attribute information, service attribute information, general information, and a user-action history, which are prepared in advance, as learning data.

Furthermore, it is preferable that the ID-value assessment device should further include a service attribute information acquisition section that analyzes information, which is written in a service provision site for providing the service, and acquires the service attribute information of the service which is provided by the corresponding service provision site.

Further, it is preferable that the service attribute information acquisition section should acquire the service attribute information by performing prescribed language processing on the information which is written in the service provision site.

Furthermore, it is preferable that the service should include a service for providing advertisements to the user. In this case, it is preferable that, when the user performs an operation relevant to the advertisement, the assessment calculation section should set the corresponding user as the user to be assessed and calculates the value assessment.

Further, it is preferable that the assessment calculation section should set a set of users, who visit the service provision site for providing the service, as a set of users to be assessed, should calculate the value assessments of the respective users included in the corresponding set, and should calculate a value-set assessment by adding up the corresponding value assessments of the respective users. In this case, it is preferable that the assessment output section should associate an ID of the service provision site with the value-set assessment, which is calculated by the assessment calculation section, and should output the ID and the value-set assessment.

Furthermore, it is preferable that the ID-value assessment device should further include a data shaping section that converts a representation of the service attribute information, which is input to the assessment function, into a representation thereof which can be input to the corresponding assessment function.

According to another embodiment of the disclosure, there is provided an ID-value assessment system including: an ID-value assessment device that has an assessment calculation section which calculates a value assessment of a user to be assessed by using an assessment function of outputting the value assessment, which represents the values of the corresponding user, in response to inputs of user attribute information representing an attribute of the user and service attribute information representing an attribute of a service and general information, and an assessment output section which outputs a user ID of the user to be assessed and the value assessment of the corresponding user, which is calculated by the assessment calculation section, in association with each other; an ad delivery server that provides a service of delivering advertisements to the user; and an ad provision server that provides content of advertisements to the ad delivery server. When the user performs an operation relevant to an advertisement which is delivered by the ad delivery server, the ad delivery server requests the ID-value assessment device to assess the corresponding user. The ID-value assessment device causes the assessment calculation section to calculate the value assessment of the user who is a target of the request issued from the ad delivery server, and causes the assessment output section to associate the value assessment of the corresponding user with the user ID of the corresponding user and outputs the value assessment and the user ID to the ad delivery server. The ad delivery server provides the value assessment of the user, which is acquired from the ID-value assessment device, together with the user ID associated with the corresponding value assessment, to the ad provision server.

According to a further embodiment of the disclosure,

there is provided an ID-value assessment method including: an assessment calculation step of calculating a value assessment of a user to be assessed by using an assessment function of outputting the value assessment, which represents the values of the corresponding user, in response to inputs of user attribute information representing an attribute of the user and service attribute information representing an attribute of a service and general information; and an assessment output step of outputting a user ID of the user to be assessed and the value assessment of the corresponding user, which is calculated by the assessment calculation step, in association with each other.

According to a still further embodiment of the disclosure, there is provided a program for causing a computer to execute functions of components provided in the ID-value assessment device. Moreover, according to a yet further embodiment of the disclosure, there is provided a computer-readable recording medium storing the program.

As described above, according to the embodiments of the disclosure, it is possible to assess the values of users on the basis of the relationship between users and services.

### BRIEF DESCRIPTION OF THE DRAWINGS

FIG. 1 is an explanatory diagram illustrating an entire configuration of an ad provision system according to an embodiment of the disclosure;

FIG. 2 is an explanatory diagram illustrating a functional configuration of an ID-value assessment system according to the embodiment;

FIG. 3 is an explanatory diagram illustrating a functional configuration of an ad delivery system according to the embodiment;

FIG. 4 is an explanatory diagram illustrating a functional configuration of an attribute management system according to the embodiment;

FIG. 5 is an explanatory diagram illustrating operations of the ID-value assessment system according to the embodiment;

FIG. 6 is an explanatory diagram illustrating operations of the ID-value assessment system according to the embodiment;

FIG. 7 is an explanatory diagram illustrating operations of the ID-value assessment system according to the embodiment;

FIG. 8 is an explanatory diagram illustrating operations of the ID-value assessment system according to the embodiment;

FIG. 9 is an explanatory diagram illustrating operations of the ID-value assessment system according to the embodiment;

FIG. 10 is an explanatory diagram illustrating operations of the ID-value assessment system according to the embodiment;

FIG. 11 is an explanatory diagram illustrating operations of the ID-value assessment system according to the embodiment;

FIG. 12 is an explanatory diagram illustrating operations of the ID-value assessment system according to the embodiment;

FIG. 13 is an explanatory diagram illustrating an example of learning sample data used to generate an ID-value assessment function according to the embodiment;

FIG. 14 is an explanatory diagram illustrating a method of generating the ID-value assessment function according to the embodiment;

FIG. 15 is an explanatory diagram illustrating a processing sequence executed in the ad provision system according to the embodiment;

FIG. 16 is an explanatory diagram illustrating a processing sequence executed in the ad provision system according to the embodiment; and

FIG. 17 is an explanatory diagram illustrating a hardware configuration capable of implementing functions of the respective systems and user terminals according to the embodiment.

### DETAILED DESCRIPTION OF EMBODIMENTS

Hereinafter, preferred embodiments of the disclosure will be described in detail with reference to the appended drawings. Note that, in this specification and the appended drawings, components that have substantially the same function and structure are denoted with the same reference numerals, and repeated description of these components is omitted.

### Regarding Order of Description

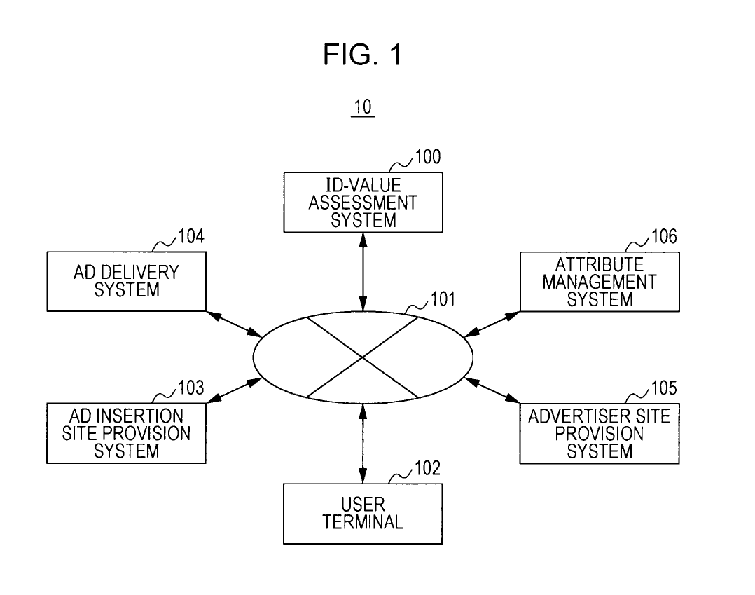

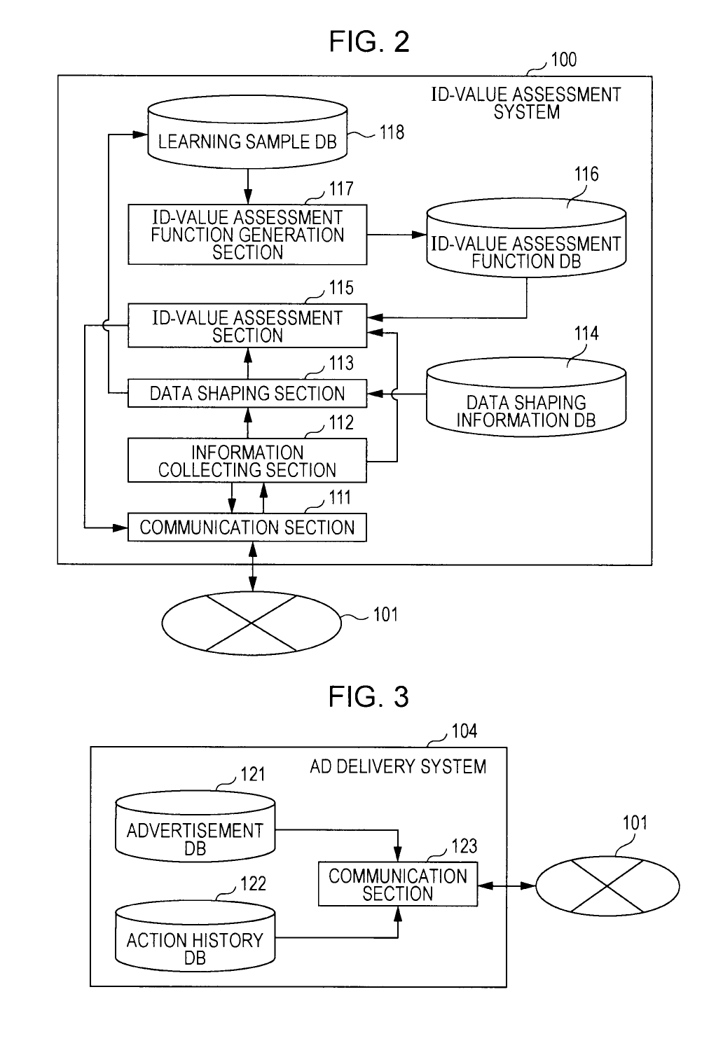

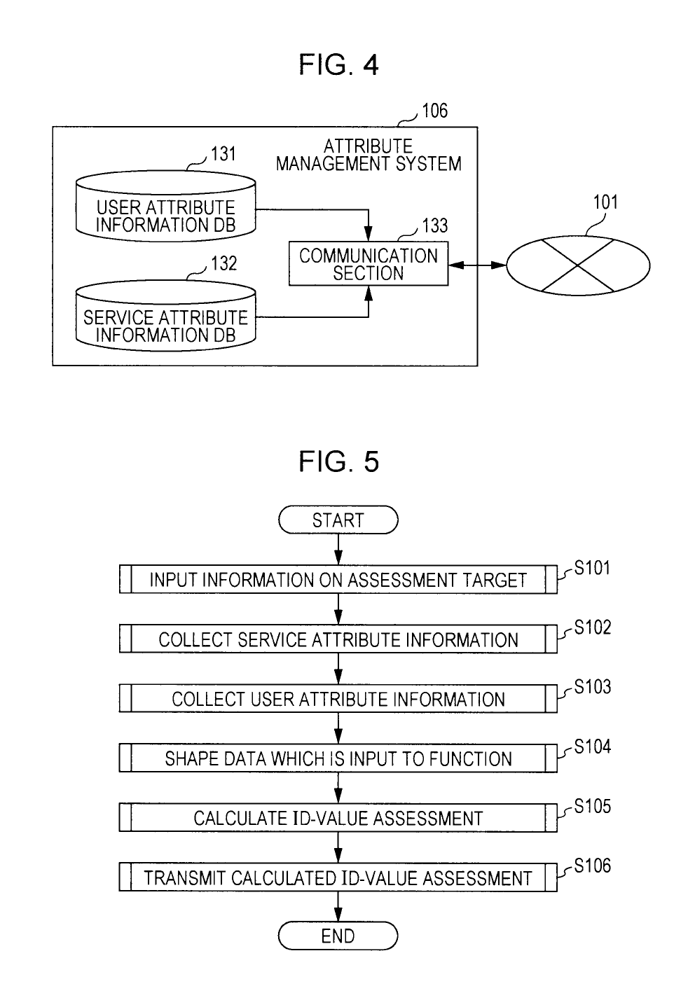

Here, in the embodiments of the disclosure to be described later, a simple order of the description is as follows. First, referring to FIG. 1, the entire configuration of an ad provision system 10 according to an embodiment of the disclosure will be described. Subsequently, referring to FIG. 2, a functional configuration of an ID-value assessment system 100 according to the embodiment will be described. Herein, a method of generating an ID-value assessment function will be described. Subsequently, referring to FIG. 3, a functional configuration of an ad delivery system 104 according to the embodiment will be described. Thereafter, referring to FIG. 4, a functional configuration of an attribute management system 106 according to the embodiment will be described.

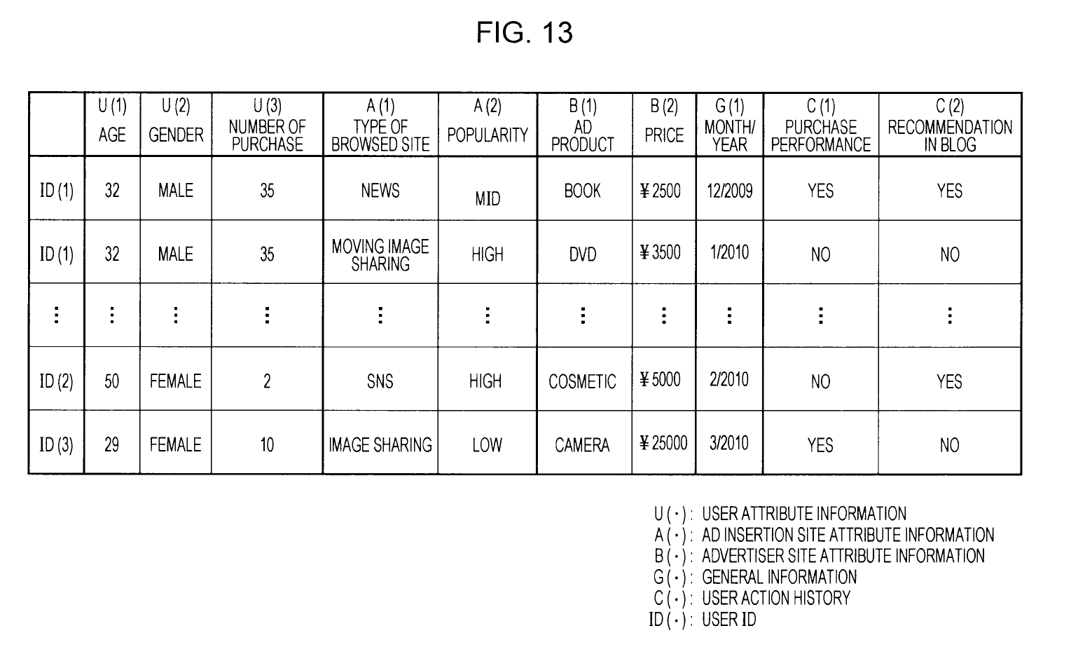

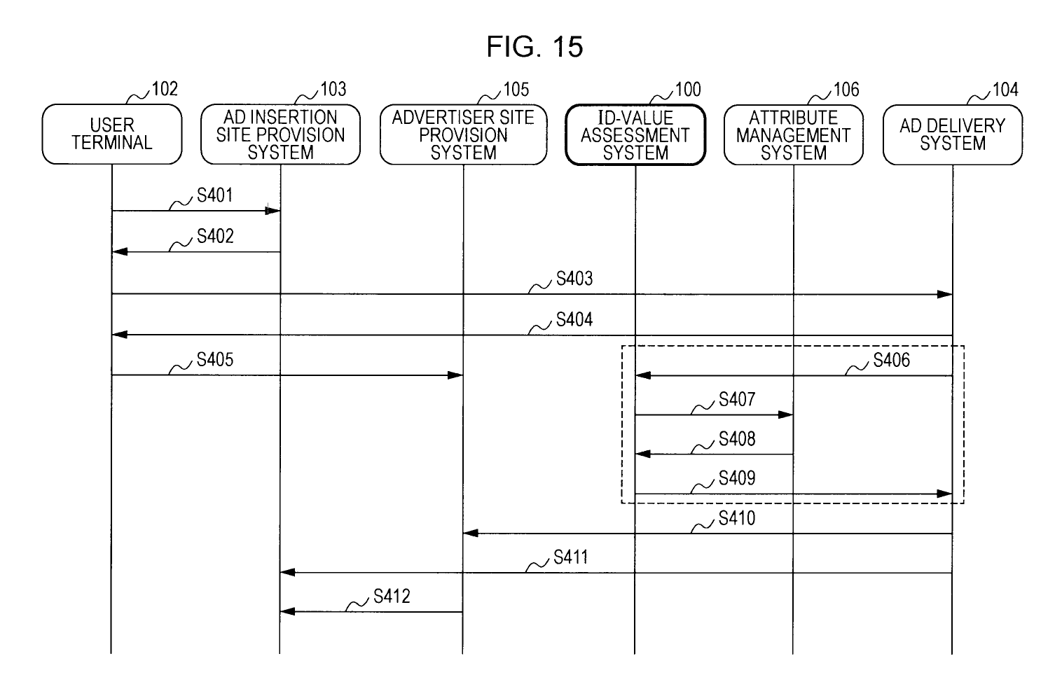

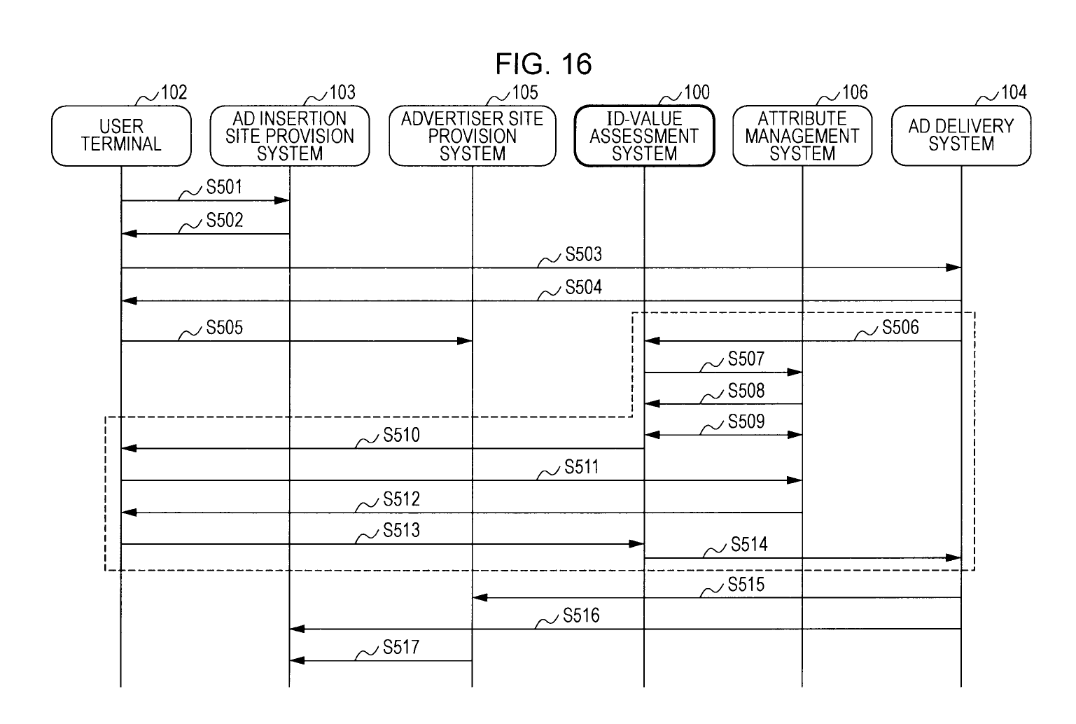

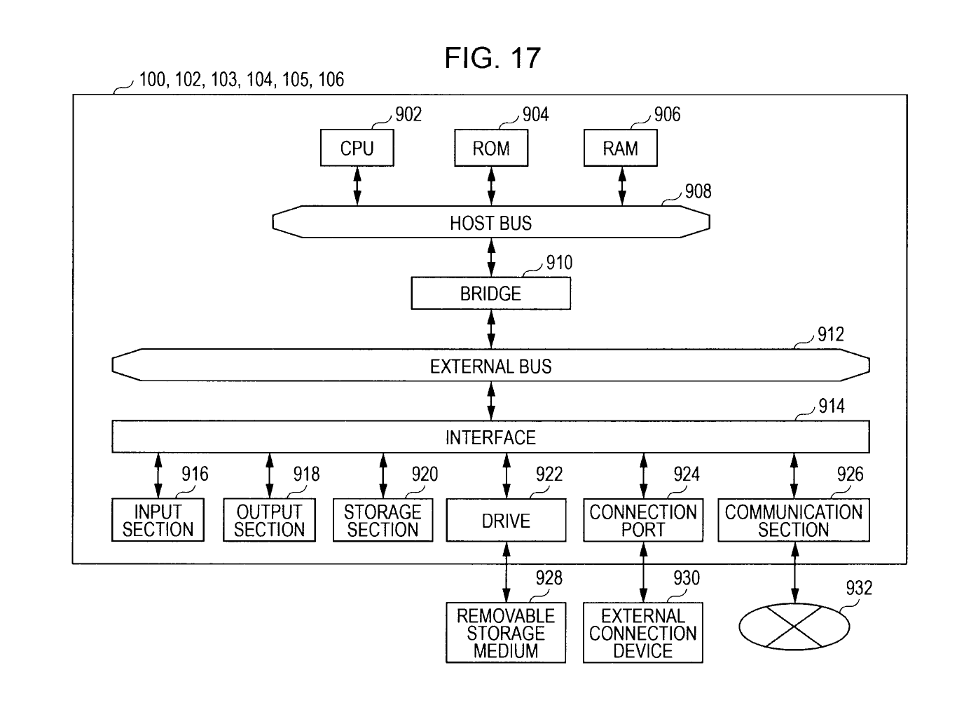

Next, referring to FIGS. 5 to 12, operations of the ID-value assessment system 100 according to the embodiment will be described. Subsequently, referring to FIG. 13, the method of generating the ID-value assessment function according to the embodiment will be described. Then, referring to FIGS. 15 and 16, a processing sequence executed in the ad provision system 10 according to the embodiment will be described. Thereafter, referring to FIG. 17, a hardware configuration capable of implementing functions of the respective systems and user terminals according to the embodiment will be described. Finally, by summarizing technical ideas of the embodiment, advantages which can be obtained from the technical ideas will be briefly described.

Description Items
1. Embodiments
   1-1. Entire Configuration of Ad Provision System 10
   1-2. Functional Configuration of ID-Value Assessment System 100
   1-3. Functional Configuration of Ad Delivery System 104
   1-4. Functional Configuration of Attribute Management System 106
   1-5. Operations of ID-Value Assessment System 100
      1-5-1. Flow of Assessment Calculation
      1-5-2. Flow of Function Generation
   1-6. Processing Sequence of Ad Provision System 10
      1-6-1. Specific Example 1
      1-6-2. Specific Example 2
   1-7. Hardware Configuration
2. Summary

### 1. Embodiments

An embodiment of the disclosure will be described. The embodiment relates to a system (the ad provision system 10) for providing advertisement to a user. In particular, the embodiment relates to a structure of computing a fee to be paid to an advertisement publisher corresponding to value of the user or value of the advertisement publisher.

1-1. Entire Configuration of Ad Provision System 10

First, referring to FIG. 1, the entire configuration of the ad provision system 10 according to the embodiment will be described. FIG. 1 is an explanatory diagram illustrating an entire configuration of the ad provision system 10 according to the embodiment of the disclosure.

As shown in FIG. 1, the ad provision system 10 includes the ID-value assessment system 100, a user terminal 102, an ad insertion site provision system 103, the ad delivery system 104, an advertiser site provision system 105, and the attribute management system 106. Further, the ID-value assessment system 100, user terminal 102, the ad insertion site provision system 103, the ad delivery system 104, the advertiser site provision system 105, and the attribute management system 106 are connected to one another through a network 101.

The user terminal 102 is a terminal apparatus used by a user. For example, the user terminal 102 has applications such as a web browser and e-mail software, and serves as a section for receiving an operation of the user. When using the user terminal 102, for example, the user may access an ad insertion site through a web browser or may access an advertiser site by clicking a banner advertisement inserted in the ad insertion site.

The ad insertion site provision system 103 is an entity for providing an ad insertion site to a user. Further, the ad insertion site is an information site in which advertisement (sometimes simply referred to as ad) such as banner advertisement is inserted. The advertisement inserted in the ad insertion site is provided by the ad delivery system 104. The ad delivery system 104 provides the advertisement to the ad insertion site, and monitors action of the user for the advertisement inserted in the ad insertion site.

For example, when the user clicks the advertisement inserted in the ad insertion site, the click event is notified to the ad delivery system 104. Through the notification, the ad delivery system 104 manages a fee based on the event that the user clicks the advertisement. Further, the ad delivery system 104 manages a cookie of the user, and manages a purchase history and the like of the user in cooperation with the advertiser site provision system 105.

For example, the ad delivery system 104 computes a fee to be paid to the publisher (ad insertion site provision system 103) of the advertisement when the user clicks the advertisement. At this time, the ad delivery system 104 requests the ID-value assessment system 100 to assess value of the user who clicked the advertisement. Then, on the basis of the value of the user assessed by the ID-value assessment system 100, the fee to be paid to the advertisement publisher is computed.

The ID-value assessment system 100 is an entity for assessing the value of the user on the basis of the user attribute information, the ad insertion site attribute information, and the advertiser site attribute information, and the like. In addition, the user attribute information, the ad insertion site attribute information, and the advertiser site attribute information are managed by the attribute management system 106. Hence, when the request of assessment is received from the ad delivery system 104, the ID-value assessment system 100 requests the attribute management system 106 to provide information on attributes, and assesses the value of the user by using the provided attribute information.

The advertiser site provision system 105 is an entity for providing the advertiser site to which the user is guided when clicking the advertisement inserted in the ad insertion site. For example, the advertiser site provision system 105 provides an e-commerce site or an information site which is administrated by the advertiser who provides a product or a service introduced in the advertisement. Further, the advertiser (the advertiser site provision system 105) is an entity for requesting the advertisement publisher (the ad insertion site provision system 103) to insert the advertisement or for paying a fee according to performance of guidance to the advertiser site.

As described, the ad provision system 10 includes six entities. Hereinafter, in the six entities, functional configurations of the ID-value assessment system 100, the ad delivery system 104, and the attribute management system 106 will be described in detail. In addition, the ID-value assessment system 100 and the attribute management system 106 may be formed as one system. Further, the ID-value assessment system 100 and the ad delivery system 104 may be formed as one system.

Moreover, the ad delivery system 104 and the ad insertion site provision system 103 may be formed as one system.

1-2. Functional Configuration of ID-Value Assessment System 100

First, referring to FIG. 2, the functional configuration of the ID-value assessment system 100 will be described. FIG. 2 is an explanatory diagram illustrating the functional configuration of the ID-value assessment system 100.

As shown in FIG. 2, the ID-value assessment system 100 mainly includes a communication section 111, an information collecting section 112, a data shaping section 113, a data shaping information database 114, an ID-value assessment section 115, an ID-value assessment function database 116, an ID-value assessment function generation section 117, and a learning sample database 118.

The communication section 111 is a section for interchanging information between different entities through the network 101. For example, the communication section 111 is used when receiving the assessment request of the user from the ad delivery system 104, transmitting a request to provide the attribute information to the attribute management system 106, or receiving the attribute information from the attribute management system 106. Further, the communication section 111 is used when providing the assessment information, which represents the values of the user, to the ad delivery system 104. Otherwise, the communication section 111 is used in transmitting and receiving information through the network 101.

However, when the request to assess the value of the user is issued from the ad delivery system 104 to the ID-value assessment system 100, the assessment request is input to the information collecting section 112 through the communication section 111. When the assessment request is input, the information collecting section 112 transmits the request to provide the attribute information to the attribute management system 106 through the communication section 111. At this time, the information collecting section 112 requests the attribute management system 106 to provide the attribute information of the user as the assessment target, the advertiser site attribute information, and the ad insertion site attribute information.

In addition, examples of the user attribute information includes age, gender, a region (post code of present location or residence, GPS information, or the like), national origin, language, time zone, job, annual income, family structure, purchase history of products or services, action history, medical history, academic background, social relationship, and the like. Moreover, examples of the user attribute information also includes thought pattern, hobby, present situation (together with a friend, together with family, or the like), family attribute information, time spent in using the Internet.

Further, examples of the advertiser site attribute information includes type of business or service provided by the advertiser, type of product, number of user accounts registered in the advertiser site, number of accesses to the advertiser site, sales performance of the advertiser, degree of confidence in the advertiser, and the like. Moreover, examples of the advertiser site attribute information also includes external indicators of the advertiser site (PageRank, and the like), fidelity to the service provided by the advertiser (number of types of service/product, or the like), target ranges (region, age, catering to general public/enthusiasts, and the like), and the like.

Further, examples of the ad insertion site attribute information includes type of business or service provided by the advertisement publisher, type of product, number of user accounts registered in the ad insertion site, number of accesses to the ad insertion site, sales performance of the advertisement publisher, degree of confidence in the advertisement publisher, and the like. Moreover, examples of the ad insertion site attribute information also includes external indicators of the ad insertion site (Page Rank, and the like), fidelity to the service provided by the advertisement publisher (number of types of service/product, or the like), target ranges (region, age, catering to general public/enthusiasts, and the like), and the like.

When the attribute management system 106 provides the user attribute information, the advertiser site attribute information, and the ad insertion site attribute information, these pieces of the attribute information are input to the information collecting section 112 through the communication section 111. When these pieces of the attribute information are input, the information collecting section 112 inputs the input attribute information to the data shaping section 113. Further, the information collecting section 112 collects general information on time and date, season, special events (bargain, TV program, festival, incident, and the like), venue of an event, and the like from the information source (not shown) which is connected to the network 101. Then, the information collecting section 112 inputs the collected general information to the ID-value assessment section 115.

In addition, the information collecting section 112 acquires a user ID of the user as the assessment target when the assessment request is issued from the ad delivery system 104 to the ID-value assessment system 100. Further, the information collecting section 112 also acquires an ID of the ad insertion site (hereinafter referred to as an ad insertion site ID), which is browsed by the user, and an ID of the advertiser site (hereinafter referred to as an advertiser site ID) corresponding to the clicked advertisement. Then, when requesting the attribute management system 106 to provide the attribute information, the information collecting section 112 presents the user ID, the ad insertion site ID, and the advertiser site ID to the attribute management system 106.

As the user ID, for example, an Open ID, a SAML (Security Assertion Markup Language), or the like is used. Further, as the user ID, an IP address, an ID assigned to a mobile phone, or the like may also be used. Furthermore, an the ad insertion site ID, for example, a name of the advertisement publisher, an IP address or a URI (Uniform Resource Identifier) of the ad insertion site, an ID of the service or the product, an ID of a campaign, or the like may be used. Moreover, as the advertiser site ID, for example, a name of the advertiser, an IP address or a URL of the advertiser site, an ID of the service or the product, an ID of a campaign, or the like may be used.

Further, the information collecting section 112 acquires an assessment item, which represents an assessment type of the user, when the assessment request is issued from the ad delivery system 104 to the ID-value assessment system 100. Examples of the assessment item includes a degree of confidence in the user, a degree of expectation in purchase, a degree of royalty, the number of friends to be influenced, a period of time necessary until purchase, a purchase amount, the number of sites (particularly, similar advertiser sites) browsed until purchase, and a combination thereof, and those correspond to the ID-value assessment. The user ID, the ad insertion site ID, the advertiser site ID, the assessment item, and the general information acquired by the information collecting section 112 are input to the ID-value assessment section 115.

However, as described above, the data shaping section 113 receives, from the information collecting section 112, the inputs of the user attribute information, the ad insertion site attribute information, and the advertiser site attribute information. When the user attribute information, the ad insertion site attribute information, and the advertiser site attribute information are input, the data shaping section 113 shapes representation of the input attribute information into representation thereof which can be input to the ID-value assessment function to be described later. At this time, the data shaping section 113 reads out information necessary to shape the representation from the data shaping information database 114, and shapes the representation by using the readout information.

For example, the data shaping section 113 changes a word expression into another word expression which is substantially the same but has a different combination of characters (for example, changes “CreditCard” into “Credit Card”). Further, the data shaping section 113 changes a word expression into another word expression which has the same meaning (for example, changes “Credit Card” into “Charge Card”). Furthermore, the data shaping section 113 associates an ontology concept with another ontology concept. In addition, information, which represents the correspondence relationship between words, is stored in the data shaping information database 114 in advance.

The attribute information, which is shaped by the data shaping section 113, is input to the ID-value assessment section 115. As described above, the ID-value assessment section 115 receives the inputs of the user ID of the user as the assessment target, the ad insertion site ID, the advertiser site ID, the general information, the assessment items, and the shaped attribute information. When such pieces of the information is input, the ID-value assessment section 115 first refers to the ID-value assessment function database 116, and acquires the ID-value assessment functions corresponding to the assessment items. However, the ID-value assessment functions described herein are functions for outputting assessments of the value of the user on the basis of the inputs of the user attribute information, the ad insertion site attribute information, and the advertiser site attribute information.

When the ID-value assessment function is acquired, the ID-value assessment section 115 inputs, to the acquired ID-value assessment function, the user attribute information, the ad insertion site attribute information, and the advertiser site attribute information which are input from the data shaping section 113, and calculates the assessment which represents the values of the user. The ID-value assessment section 115, which calculated the assessment, associates the assessment with a set of the user ID, the ad insertion site ID, and the advertiser site ID, and transmits the corresponding assessment to the ad delivery system 104 through the communication section 111. Further, when the output of the ID-value assessment function is an abnormal value, the ID-value assessment section 115 notifies an abnormality to the ad delivery system 104 through the communication section 111.

Regarding Functional Configuration for Generation of ID-Value Assessment Function

As described above, the ID-value assessment function database 116 stores the ID-value assessment functions which are generated for each assessment item. The ID-value assessment functions stored in the ID-value assessment function database 116 are generated by the ID-value assessment function generation section 117. The ID-value assessment function generation section 117 is a section for generating ID-value assessment functions through machine learning on the basis of the learning sample data stored in the learning sample database 118 in advance.

The learning sample data includes the user attribute information, the ad insertion site attribute information, the advertiser site attribute information, the general information, and the user-action history (refer to FIG. 13). The learning sample data is collected by the information collecting section 112, is shaped by the data shaping section 113 so as to be appropriate for the inputs of the ID-value assessment functions, and is then stored in the learning sample database 118. When the learning sample data is used, it is possible to generate the ID-value assessment functions of outputting the assessments based on the user-action history, in response to the inputs of the user attribute information, the ad insertion site attribute information, the advertiser site attribute information, and the general information.

For example, when a purchase action (for example, presence of the purchase action=1, absence of the purchase action=0) is given as the user-action history, the ID-value assessment function generation section 117 is able to generate an ID-value assessment function of outputting a degree of expectation in the purchase of the user as an assessment. When a recommendation action (for example, presence of the recommendation action=1, absence of the recommendation action=0) in a blog is given as the user-action history, the ID-value assessment function generation section 117 is able to generate an ID-value assessment function of outputting a degree of expectation in the recommendation of the user in the blog as an assessment. In addition, the methods used in the machine learning are, for example, as follows: a SVM (Support Vector Machine), a simple Bayes classifier, linear discrimination, quadratic discrimination, neural network, perceptron, and the like.

As described above, the ID-value assessment functions generated by the ID-value assessment function generation section 117 are stored in the ID-value assessment function database 116.

Supplementary Description about Assessment

The assessment, which is calculated by the ID-value assessment system 100, represents a possibility that a user purchases a product or a service introduced by the advertisement, a possibility that the user introduces the product or the service to friends or acquaintances, or a possibility that the user visits the advertiser site again in the future. Further, the assessment is considered to be influenced by the user attribute information, the ad insertion site attribute information, the advertiser site attribute information, and the general information. In addition, the user attribute information, the ad insertion site attribute information, the advertiser site attribute information, and the general information are changed in real time. Hence, it is necessary to compute the assessment in real time in accordance with the change.

As described above, the assessment is calculated by the ID-value assessment system 100 for every user. However, when the assessments of the entire set of the users who visit the ad insertion site are added up, it is possible to obtain an assessment which represents power of influence of the ad insertion site. Hence, the ID-value assessment system 100 may calculate the assessment which represents power of influence of the ad insertion site. Such an assessment may be used as objective data when a fee of the advertisement is demanded from the advertiser. Further, even when searching an ad insertion site in which the effect of the advertisement is high, it may possible to use the assessment.

Supplementary Description about Collection of Attribute Information

There are various types in the user attribute information, the ad insertion site attribute information, and the advertiser site attribute information. Further, in accordance with the assessment items, some pieces of the attribute information may not be used when the assessment is calculated. Hence, the information collecting section 112 may be configured to collect only pieces of the attribute information which are used in the calculation of the assessment in accordance with the assessment items. That is, after acquiring the assessment items, the information collecting section 112 may be configured to select only the pieces of the attribute information, which are used as inputs of the ID-value assessment functions selected in accordance with the assessment items, so as to acquire only the selected pieces of the attribute information from the attribute management system 106.

Further, the information collecting section 112 extracts each of the ad insertion site attribute information and the advertiser site attribute information not from the attribute management system 106 but directly from the ad insertion site and the advertiser site. For example, the information collecting section 112 analyzes the inside of the ad insertion site through text mining or natural language processing, and is able to obtain the ad insertion site attribute information from the analysis result. Likewise, the information collecting section 112 analyzes the inside of the advertiser site through text mining or natural language processing, and is able to obtain the advertiser site attribute information from the analysis result.

Further, the information collecting section 112 may be able to collect the user attribute information not from the attribute management system 106 but by using the user ID. For example, the information collecting section 112 is able to collect the user attribute information by using an ID-related technique such as the Open ID or SAML. Further, the information collecting section 112 is able to obtain the user attribute information by combining IDs between the services on the basis of the purchase histories and the communication histories of the user terminal 102 (such as mobile phone or PC) which remain when users use the services. Moreover, the information collecting section 112 may be able to obtain the attribute information, which is released to public through the social networking services, as the user attribute information.

Supplementary Description about Collection of Learning Sample Data

The above-described method is used in a method of collecting the user attribute information, the ad insertion site attribute information, the advertiser site attribute information, and the general information in the learning sample data. Meanwhile, when the user-action histories are intended to be collected, for example, the cookies, which are collected by the ad delivery system 104, are used. In the cookie (such as a referrer field), the user ID, the address of the ad insertion site, and the address of the advertiser site are stored. Therefore, the information collecting section 112 acquires the purchase histories, which are retained in the advertiser site, and associates the histories with the information stored in the cookies, thereby obtaining the user-action histories in which the purchase histories of the advertiser site and the ad insertion site are combined.

In addition, a method using the analysis result of the blog or the communication history and the purchase history which remains in the user terminal 102 can also be considered. Further, a method of using external marketing data (such as POS (Point Of Sale)) can also be considered. For example, it may be possible to use information in which a user having an attribute of A is highly likely to purchase a product #1 having a characteristic of B and a product #2 having a characteristic of C. In this case, the user attribute information is set to A, the ad insertion site attribute information and the advertiser site attribute information are respectively set to B and C (attributes of the products dealt in the sites), and the user-action history is set to “presence of the purchase action”, and those can be used as the learning sample data.

Supplementary Description about ID-Value Assessment Function

The ID-value assessment function is a function of outputting an assessment on the basis of the inputs of the user attribute information, the ad insertion site attribute information, the advertiser site attribute information, and the like. As described above, the ID-value assessment function is generated for each assessment item. However, among the user attribute information, the ad insertion site attribute information, and the advertiser site attribute information, some of the information can be easily acquired, but some of the information is hard to be acquired. Hence, it is preferable that a plurality of ID-value assessment functions, between which combinations of the pieces of the attribute information to be input are different, should be provided for each of the same assessment items. Examples of the attribute information, which can be easily acquired, include public information, basic attributes which are defined by the OpenID Simple Registration Extension, and the like. On the other hand, examples of the attribute information, which is hard to be acquired, include a medial history, a social relationship, a thought pattern, and the like.

Supplementary Description about Generation of ID-Value Assessment Function

A specific method of generating the ID-value assessment function will be described. As described above, the ID-value assessment function is generated through the machine learning using the learning sample data.

(A) Case Where User-Action History Can Be Binarized

When the action history such as the purchase history of a product or a service can be represented in a binary form (for example, presence of the purchase action/absence of the purchase action), it is possible to form a discriminant function of outputting a binary value through a method such as the SVM. When the user-action history is determined by using the discriminant function, such a method determines parameters of the discriminant function by using the learning sample data so as to minimize a loss function (such as a discrimination error rate). In addition, the discriminant function, which is obtained in such a method, is used as the ID-value assessment function.

As an example, a method of generating the discriminant function f(x) through the linear SVM will be described. In the case of the linear SVM, the discriminant function f(x) can be represented by the following Expression (1). Here, wⱼ represents a weight, b represents a bias term, d represents a dimension number, and x=(x₁, . . . , x_{d}) represents an attribute value. Further, a condition in a case where the function belongs to one class is represented by f(x)≧0, and a condition in a case where the function belongs to the other class is represented by f(x)<0. For example, when it is desirable to obtain an ID-value assessment function of assessing a degree of expectation in purchase of the user, the one class is set as “presence of the purchase action”, and the other class is set as “absence of the purchase action”. In normal discrimination, the binary discriminant function g(x)={y|y=0 when f(x)≧0, y=1 when f(x)<0} is created, and finally it is determined whether the purchase action is present (g(x)=0) or is absent (g(x)=1). However, as the ID-value assessment function, it is possible to use both of the discriminant function f(x), which is able to receive a continuous value, and the binary discriminant function g(x).

$$f ( x ) = {\sum }_{j = 1}^{d} {w}_{j} \cdot {x}_{j} + b \qquad ( 1 )$$

By assigning an attribute value (a numerical part of the attribute information) included in the learning sample data to x, the weight wⱼ and the bias term b are adjusted such that the calculated value of f(x) is appropriate for the user-action history included in the learning sample data. Then, the adjustment is repeated until it is possible to obtain the discriminant function f(x) appropriate for the user-action history in the entire learning sample data or in the range of a predetermined rate or more. By executing such processing, it is possible to obtain the discriminant function f(x) from the learning sample data.

In addition, in the case of the Bayes classifier, it is possible to obtain a conditional probability p (user action/attribute information, general information) from the learning sample data, and thus the conditional probability p is used as the ID-value assessment function. Further, in the cases of the linear discrimination, the quadratic discrimination, the neural network, and the perceptron, it is possible to obtain the discriminant function the same as the linear SVM, and thus the discriminant function is used as the ID-value assessment function. Such a method is a method using one discriminant function, but a method such as boosting using a plurality of discriminant functions in combination may be used.

(B) Method of Generating ID-Value Assessment Function through Boosting

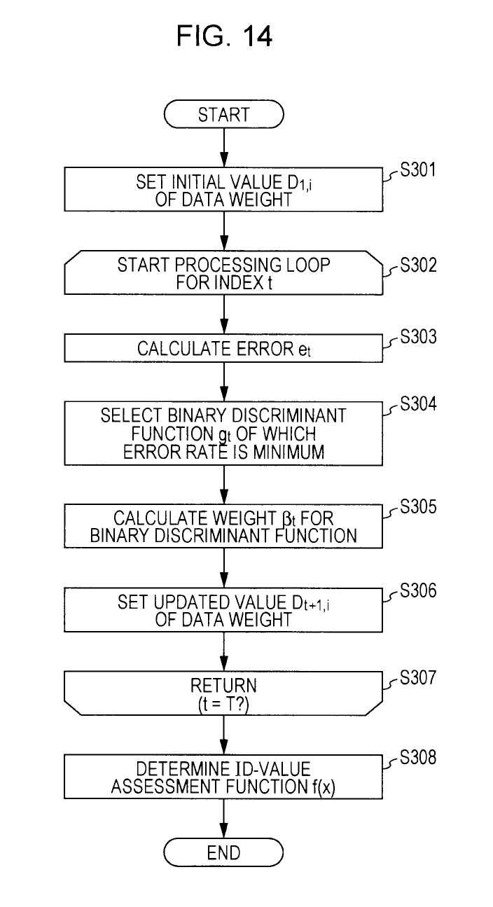

Next, referring to FIG. 14, a method of generating the ID-value assessment function through the boosting will be described. FIG. 14 is an explanatory diagram illustrating the method of generating the ID-value assessment function through the boosting. In addition, the boosting is a method of not generating one high-accuracy identifier but combining multiple low-accuracy identifiers (weak identifiers) so as to thereby generate a high-accuracy identifier (a strong identifier). Here, the case of using the binary discriminant functions as the weak identifiers will be considered, where the binary discriminant functions are generated by the simple Bayes classifier, the linear discrimination, the quadratic discrimination, the neural network, the perceptron, a correlation rule, a decision tree, and the like.

The binary discriminant function is a function of outputting 0 or 1 with respect to the input of the value x (for example, the attribute information). For example, the discriminant function f, which is generated by the linear SVM described above, was the function of outputting a continuous value with respect to the input of the attribute value x. However, normally, the mostly used function is the binary discriminant function g(x)={y|y=0 when f(x)≧0, y=1 when f(x)<0} which outputs 0 when f(x)≧0 and outputs 1 when f(x)<0. Therefore, a method of generating the ID-value assessment function f(x) corresponding to the strong identifier by providing a plurality of the binary discriminant functions g(x) and by using these binary discriminant functions g(x) will be considered.

Hereinafter, the attribute value of each of the attribute information and the general information included in the learning sample data is represented by xᵢ. Further, the attribute value, which represents the user-action history included in the learning sample data, is represented by yᵢ Here, yᵢ is represented in binary (+1, −1). For example, the “presence of the purchase action” is represented by +1, and the “absence of the purchase action” is represented by −1. Further, the number of the learning samples included in the learning sample data is represented by N. In addition, the processing to be described below is executed by the ID-value assessment system 100 (the ID-value assessment function generation section 117).

As shown in FIG. 14, the ID-value assessment system 100 first sets initial values D_{1, i} of the data weight as represented by the following Expression (2) (S301). At this time, all the initial values D_{1, i} (i=1 to N) are set to an identical value. Subsequently, the ID-value assessment system 100 starts a processing loop for the index t (t=1 to T) (S302). Then, the ID-value assessment system 100 inputs the attribute value xᵢ to the binary discriminant function gₜ(x), calculates gₜ(xᵢ), and compares the output value gₜ(xᵢ) with the attribute value yᵢ, thereby calculating an error rate eₜ (refer to the following Expression (3)) (S303).

Thereafter, the ID-value assessment system 100 selects the binary discriminant function gₜ(x) by which the calculated error rate eₜ is minimized (S304). Subsequently, the ID-value assessment system 100 calculates a weight βₜ through the following Expression (4) by using the error rate eₜ corresponding to the binary discriminant function gₜ(x) which is selected in step S304 (S305). Then, the ID-value assessment system 100 sets an updated value D_{t+1, i} of the data weight on the basis of the following Expressions (5) and (6) (S306). In addition, the following Expression (6) represents processing of normalizing the updated value D_{t+1, i} of the data weight.

Subsequently, the ID-value assessment system 100 determines whether or not the index t is equal to T (S307). If t≠T, the ID-value assessment system 100 increments the index t by 1, and returns the processing to step S303 (S307). In contrast, if t=T, the ID-value assessment system 100 advances the processing to step S308. When advancing the processing to step S308, the ID-value assessment system 100 determines the ID-value assessment function f(x) on the basis of the following Expression (7) (S308).

$$\begin{matrix}{D}_{1 , i} = \frac{1}{N} & ( 2 ) \\ {e}_{t} = {\sum }_{\{ i : {g}_{t} ( {x}_{l} ) \neq {y}_{i} \}} {D}_{t , i} & ( 3 ) \\ {β}_{t} = \frac{1}{2} ln ( \frac{1 - {e}_{t}}{{e}_{t}} ) & ( 4 ) \\ {D}_{t + 1 , i} = {D}_{t , i} exp ( - {β}_{t} \cdot {g}_{t} ( {x}_{i} ) ) & ( 5 ) \\ {D}_{t + 1 , i} ← \frac{{D}_{t + 1 , i}}{{\sum }_{i} {D}_{t + 1 , i}} & ( 6 ) \\ f ( x ) = {\sum }_{t = 1}^{T} {β}_{t} \cdot {g}_{t} ( x ) & ( 7 )\end{matrix}$$

Hitherto, the method of generating the ID-value assessment function through the boosting has been described.

(C) Case Where User-Action History Is Represented by Ternary or More Discrete Value

The case where the user-action history such as an accumulated purchase amount or the number of accesses to the advertiser site is represented by a ternary or more discrete value will be considered. Examples of the user-action history, which has a ternary or more discrete value, include the number of visitors to a blog, the number of SNS friends, the number of days passing until a product or a service is purchased, a purchase amount, the number of times the same advertisement is viewed until purchase, and the like. As a method of handling such an action history, for example, the following methods (C-1) and (C-2) are considered.

(C-1) Method Using Class Separation

Here, two methods using class separation will be introduced.

(C-1-1) First Method

This method is a method of generating the discriminant function for each discrete value through the method described in the section (A) and outputting the discrete value, which corresponds to a discriminant function of outputting a maximum value in response to an input of a certain piece of the attribute information, as an assessment. For example, when the “period until purchase” is considered as the assessment (when “the action history=the number of days passing until purchase”), first, N+1 discriminant functions corresponding to 0 to N days are generated. Then, when a certain piece of the attribute information is given as an input, the number of days corresponding to the discriminant function of which the output value is at the maximum is set as an assessment. In this case, as the discriminant function, the simple Bayes classifier is used.

(C-1-2) Second Method

This method is a method of generating a plurality of binary discriminant functions (output value: 0, 1) for each discrete value and setting a discrete value, which corresponds to a binary discriminant function of which the number of the output values equal to 0 (or 1) is at the maximum by majority in response to an input of a certain piece of the attribute information, as an assessment. For example, when the “period until purchase” is considered as the assessment (when “the action history=the number of days passing until purchase”), the plurality binary discriminant functions (purchase=0) is generated for each of N+1 days of 0 to N days. Then, when a certain piece of the attribute information is given as an input, the number of the binary discriminant functions, of which the output values are equal to 0, is calculated, and the number of days, which corresponds to the case where the number of the binary discriminant functions is at the maximum, is set as an assessment.

(C-2) Method Using Regression Analysis

This method is a method of estimating a discrete value by performing regression analysis on the basis of the learning sample data. In the case of the method, a regression function, which is obtained by the regression analysis, is used as the ID-value assessment function. In addition, the regression analysis is a matter of estimating a real value corresponding to the given data, and includes linear regression, logistic regression, support vector regression, and the like. In addition, the method using the regression analysis can also be used in the case where the ID value is a continuous value.

(D) Combination Method

This method is a method of attaching appropriate weights to the plurality of discriminant functions, which are generated in (A) and (C) having the input of the same attribute information, and adding them to each other. For example, when emphasis is placed on the fact that a user uses the advertiser site for a long period of time, a weight of the ID-value assessment function, which relates to the degree of royalty of the user or the number of acquaintances/friends to be influenced, is set to be large, a degree of expectation in purchase of the user is set to be small, and those are added to each other. In this case, in order to facilitate comparison between the plurality of ID-value assessment function, it is preferable that the output value of the discriminant function should be normalized (the discriminant function is divided by the maximum of the absolute value of the discriminant function).

(D-1) Combination Example #1: Affiliate Fee per One Site

Although a user is guided from the ad insertion site to the advertiser site, the user does not directly purchase a product or a service. For example, there is a possibility that the product or the service is purchased in the future. In the above description, when purchase is made later, a fee is paid from the advertiser site only to the ad insertion site which a user views at the last time. However, the user is likely to repeatedly view the same advertisement multiple times until purchase is made after the user views the advertisement at the first time. Hence, originally, all the ad insertion sites, in which the advertisement is inserted, should be equally paid.

In such a case, on the basis of the ID value, a fee to be paid to one site can be calculated by the following expression: (an affiliate fee)×(a purchase probability calculated on the basis of the degree of expectation in purchase of the user)/(the number of times user views the same advertisement until purchase). Further, the probability of purchase of the user can be calculated on the basis of the degree of expectation in purchase by the following expression: |(the degree of expectation in purchase of the user)−(the minimum degree of expectation in purchase of the user)|/|(the maximum degree of expectation in purchase of the user)−(the minimum degree of expectation in purchase of the user)|. In addition, the affiliate fee can be determined on the basis of an advertisement budget of the advertiser.

(D-2) Combination Example #2: Value of User in which User's Friends are Additionally Considered

The ID-value assessment function, in which the degrees of expectation in purchase of not only the user but also the user's friends are added, is given by, for example, the following expression: (the degree of expectation in purchase of the user)+(the number of friends)×(the degree of expectation in purchase of the friend)×(an update frequency of the blog/SNS of the user)×(a probability that the user picks up the product due to the contents of the blog/SNS). The degree of expectation in purchase of the friend also depends on the type of the blog, but the friend is considered to have the same attribute as the user, and thus, for example, the discriminant function the same as the degree of expectation in purchase of the user is used. Since the update frequency of the blog/SNS of the user and the contents of the blog/SNS of the user are public information, the discriminant functions of estimating them can be easily generated through the machine learning.

Hitherto, the functional configuration of the ID-value assessment system 100 has been described. The above description shows the example of the configuration in which the ID-value assessment system 100 generates the ID-value assessment functions, but the configuration of the ID-value assessment system 100 is not limited to this. For example, the ID-value assessment system 100 may be configured to use the ID-value assessment functions which are provided in advance from the outside. In this case, the configurations of the ID-value assessment function generation section 117 and the learning sample database 118 is omitted from the ID-value assessment system 100.

1-3. Functional Configuration of Ad Delivery System 104

Next, referring to FIG. 3, the functional configuration of the ad delivery system 104 will be described. FIG. 3 is an explanatory diagram illustrating the functional configuration of the ad delivery system 104.

As shown in FIG. 3, the ad delivery system 104 mainly includes an advertisement database 121, an action history database 122, and a communication section 123.

The advertisement database 121 is a storage section for storing the advertisement which is provided by the advertiser site provision system 105. Further, the action history database 122 is a storage section for storing the user-action history which is collected from the user terminal 102 and the ad insertion site provision system 103. The communication section 123 is a communication section for communicating with each entity which is connected to the network 101.

For example, the communication section 123 receives the advertisement from the advertiser site provision system 105, and stores the received advertisement in the advertisement database 121. Further, the communication section 123 receives the user-action history from the user terminal 102 and the ad insertion site provision system 103, and stores the received action histories in the action history database 122. Moreover, when receiving a request from the ID-value assessment system 100, the communication section 123 reads out the user-action history from the action history database 122, and transmits the readout action history to the ID-value assessment system 100.

Further, the ad delivery system 104 may further include a fee calculation section (not shown) for calculating the fee to be paid to the advertisement publisher. When the advertisement inserted in the ad insertion site is clicked, the fee calculation section requests the ID-value assessment system 100 to calculates an assessment, and calculates a fee on the basis of the calculated assessment which is calculated by the ID-value assessment system 100. Information on the fee, which is calculated by the fee calculation section, is transmitted to the advertiser site provision system 105 and the ad insertion site provision system 103 through the communication section 123.

As described above, since the ID-value assessment system 100 assesses value of the user in real time, it is possible to determine the fee to be paid to the advertisement publisher in real time when the advertisement inserted in the ad insertion site is clicked.

Hitherto, the functional configuration of the ad delivery system 104 has been described.

1-4. Functional Configuration of Attribute Management System 106

Next, referring to FIG. 4, the functional configuration of the attribute management system 106 will be described. FIG. 4 is an explanatory diagram illustrating the functional configuration of the attribute management system 106.

As shown in FIG. 4, the attribute management system 106 mainly includes a user attribute information database 131, a service attribute information database 132, and a communication section 133.

The user attribute information database 131 is a storage section for storing the user attribute information. Further, the service attribute information database 132 is a storage section for storing the ad insertion site attribute information and the advertiser site attribute information. The communication section 133 is a communication section for communicating with each entity which is connected to the network 101.

For example, the communication section 133 acquires the user attribute information from the information source which is connected to the user terminal 102 or the network 101, and stores the acquired user attribute information in the user attribute information database 131. Further, the communication section 133 acquires the ad insertion site attribute information from the information source which is connected to the ad insertion site provision system 103 or the network 101, stores the acquired ad insertion site attribute information in the service attribute information database 132. Moreover, the communication section 133 acquires the advertiser site attribute information from the information source which is connected to the advertiser site provision system 105 or the network 101, and stores the acquired advertiser site attribute information in the service attribute information database 132.

Further, when receiving a request to provide the user attribute information from the ID-value assessment system 100, the communication section 133 reads out the user attribute information from the user attribute information database 131, and transmits the readout user attribute information to the ID-value assessment system 100. When receiving a request to provide the ad insertion site attribute information from the ID-value assessment system 100, the communication section 133 reads out the ad insertion site attribute information from the service attribute information database 132, and transmits the readout ad insertion site attribute information to the ID-value assessment system 100. When receiving a request to provide the advertiser site attribute information from the ID-value assessment system 100, the communication section 133 reads out the advertiser site attribute information from the service attribute information database 132, and transmits the readout advertiser site attribute information to the ID-value assessment system 100.

Hitherto, the functional configuration of the attribute management system 106 has been described.

1-5. Operations of ID-Value Assessment System 100

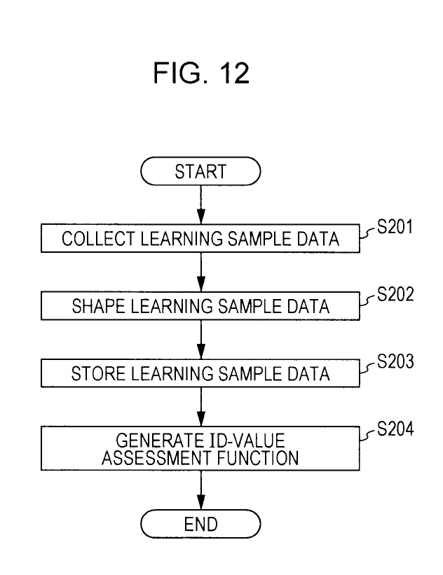

Next, the operations of the ID-value assessment system 100 will be described. First, referring to FIGS. 5 to 11, the operations of the ID-value assessment system 100 relevant to the assessment calculation will be described. Subsequently, referring to FIG. 12, the operations of the ID-value assessment system 100 relevant to generation of the ID-value assessment function will be described.

1-5-1. Flow of Assessment Calculation

First, refer to FIG. 5. As shown in FIG. 5, the ID-value assessment system 100 receives an input of information on the assessment target (S101). In step S101, as the information on the assessment target, the user ID, the ad insertion site ID, the advertiser site ID, the assessment item, the general information, and the like are input to the ID-value assessment system 100.

Subsequently, the ID-value assessment system 100 collects the ad insertion site attribute information and the advertiser site attribute information (S102). For example, the ID-value assessment system 100 acquires the ad insertion site attribute information and the advertiser site attribute information from the attribute management system 106 by using the ad insertion site ID and the advertiser site ID which are input in step S101. However, the ID-value assessment system 100 may collect ad insertion site attribute information by analyzing the ad insertion site, and may collect the advertiser site attribute information by analyzing the advertiser site.

Subsequently, the ID-value assessment system 100 collects the user attribute information (S103). For example, the ID-value assessment system 100 acquires the user attribute information from the attribute management system 106 by using the user ID which is input in step S101. Subsequently, the ID-value assessment system 100 shapes a data format of the user attribute information, the ad insertion site attribute information, and the advertiser site attribute information such that the data format is suitable for the input format of the ID-value assessment function (S104).

Subsequently, the ID-value assessment system 100 inputs the user attribute information, the ad insertion site attribute information, the advertiser site attribute information, and the general information, which are shaped in step S104, to the ID-value assessment function, and calculates the assessment which represents the values of the user (ID-value assessment) (S105). Subsequently, the ID-value assessment system 100 transmits the assessment, which is calculated in step S105, to the ad delivery system 104 (the assessment client) (S106).

Hitherto, the flow of the assessment calculation has been briefly described. Hereinafter, respective steps S101 to S106 will be described in further detail.

Regarding Processing of S101

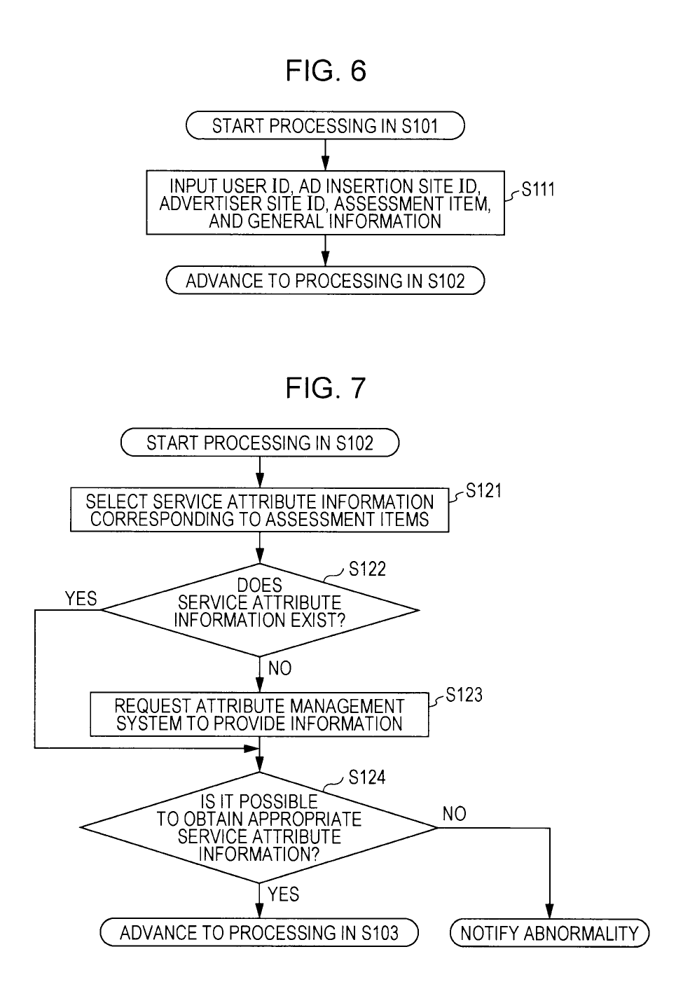

Next, refer to FIG. 6. As shown in FIG. 6, when the processing of step S101 is started, the ID-value assessment system 100 receives inputs of the user ID, the ad insertion site ID, the advertiser site ID, the assessment item, and the general information (S111).

Here, the input user ID is identification information for identifying the user as the assessment target. Further, the ad insertion site ID is identification information for identifying the ad insertion site in which the advertisement clicked by the user is inserted. In addition, the advertiser site ID is identification information for identifying the advertiser (the advertiser site) of the advertisement which is clicked by the user. Here, the input assessment item is information for specifying the type of the assessment (such as the degree of expectation in purchase, the degree of loyalty, the degree of expectation in purchase of the friend, or the degree of expectation in revisiting the advertiser site). Further, the general information is information unrelated to the ad insertion site or the advertiser site.

When such information is input, the ID-value assessment system 100 advances the processing to step S102.

Regarding Processing of S102

Next, refer to FIG. 7. As shown in FIG. 7, when the processing of step S102 is started, the ID-value assessment system 100 first selects the service attribute information (the ad insertion site attribute information and the advertiser site attribute information) in accordance with the assessment item (S121).

Examples of the advertiser site attribute information includes type of business or service provided by the advertiser, type of product, number of user accounts registered in the advertiser site, number of accesses to the advertiser site, sales performance of the advertiser, degree of confidence in the advertiser, and the like. Moreover, examples of the advertiser site attribute information also includes external indicators of the advertiser site (PageRank, and the like), fidelity to the service provided by the advertiser (number of types of service/product, or the like), target ranges (region, age, catering to general public/enthusiasts, and the like), and the like.

Further, examples of the ad insertion site attribute information includes type of business or service provided by the advertisement publisher, type of product, number of user accounts registered in the ad insertion site, number of accesses to the ad insertion site, sales performance of the advertisement publisher, degree of confidence in the advertisement publisher, and the like. Moreover, examples of the ad insertion site attribute information also includes external indicators of the ad insertion site (Page Rank, and the like), fidelity to the service provided by the advertisement publisher (number of types of service/product, or the like), target ranges (region, age, catering to general public/enthusiasts, and the like), and the like.

As described above, the advertiser site attribute information and the ad insertion site attribute information have a wide variety of types. However, not all the advertiser site attribute information and the ad insertion site attribute information are collected by the ID-value assessment system 100. Further, when the assessment is calculated, not all the advertiser site attribute information and the ad insertion site attribute information are used. Further, for each ID-value assessment function, combination of the input advertiser site attribute information and the input ad insertion site attribute information is different. Hence, it is necessary to select the appropriate advertiser site attribute information or the appropriate ad insertion site attribute information for each different ID-value assessment function in accordance with the type of the assessment.

For this reason, in step S121, in accordance with the assessment item, the advertiser site attribute information or the ad insertion site attribute information to be used in the calculation of the assessment is selected. When the selection of the advertiser site attribute information or the ad insertion site attribute information is completed, the ID-value assessment system 100 advances the processing to step S122. The ID-value assessment system 100, which advanced the processing to step S122, determines whether or not the advertiser site attribute information or the ad insertion site attribute information selected in step S121 exists (S122).

As described above, the embodiment of the disclosure is not limited such that it is possible to collect all the advertiser site attribute information and the ad insertion site attribute information. Hence, the ID-value assessment system 100 confirms whether or not the advertiser site attribute information or the ad insertion site attribute information necessary for the calculation of the assessment exists. If the advertiser site attribute information or the ad insertion site attribute information selected in step S121 exists, the ID-value assessment system 100 advances the processing to step S124. In contrast, if the advertiser site attribute information or the ad insertion site attribute information selected in step S121 does not exist, the ID-value assessment system 100 advances the processing to step S123.

When advancing the processing to step S123, the ID-value assessment system 100 requests the attribute management system 106 to provide the necessary advertiser site attribute information or the necessary ad insertion site attribute information (S123). After acquiring the necessary advertiser site attribute information or the necessary ad insertion site attribute information from the attribute management system 106, the ID-value assessment system 100 advances the processing to step S124.

The ID-value assessment system 100, which advanced the processing to step S124, determines whether or not it is possible to obtain the appropriate advertiser site attribute information or the appropriate ad insertion site attribute information necessary for the calculation of the assessment (S124). If it is possible to obtain the appropriate advertiser site attribute information or the appropriate ad insertion site attribute information, the ID-value assessment system 100 advances the processing to step S103. In contrast, if it is difficult to obtain the appropriate advertiser site attribute information or the appropriate ad insertion site attribute information, the ID-value assessment system 100 notifies abnormality to the client of the assessment (the ad delivery system 104).

Regarding Processing of S103

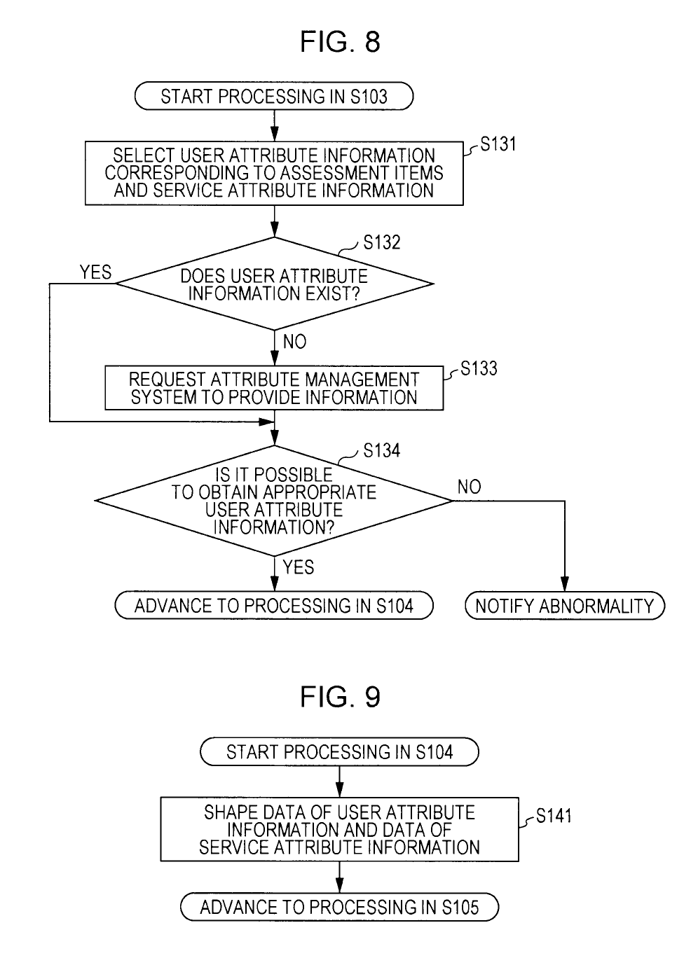

Next, refer to FIG. 8. As shown in FIG. 8, when the processing of step S103 is started, the ID-value assessment system 100 selects the user attribute information in accordance with the assessment item and the advertiser site attribute information or the ad insertion site attribute information (S131). Subsequently, the ID-value assessment system 100 determines whether or not the user attribute information selected in step S131 exists (S132). If the user attribute information selected in step S131 exists, the ID-value assessment system 100 advances the processing to step S134. In contrast, if the user attribute information selected in step S131 does not exist, the ID-value assessment system 100 advances the processing to step S133.

When advancing the processing to step S133, the ID-value assessment system 100 requests the attribute management system 106 to provide the user attribute information (S133), advances the processing to step S134. When advancing the processing to step S134, the ID-value assessment system 100 determines whether the appropriate user attribute information exists, or whether or not it is possible to obtain the appropriate user attribute information from the attribute management system 106 (S134). As a result, if the appropriate user attribute information exists, the ID-value assessment system 100 advances the processing to step S104. In contrast, if the appropriate user attribute information does not exist, the ID-value assessment system 100 notifies abnormality to the client of the assessment (the ad delivery system 104).

Regarding Processing of S104

Next, refer to FIG. 9. As shown in FIG. 9, when the processing of step S104 is started, the ID-value assessment system 100 shapes the data format of the user attribute information, the advertiser site attribute information, and the ad insertion site attribute information into the data format which can be input to the ID-value assessment function (S141). For example, the ID-value assessment system 100 changes a word expression into another word expression which is substantially the same but has a different combination of characters (for example, changes “CreditCard” into “Credit Card”). Further, ID-value assessment system 100 changes a word expression into another word expression which has the same meaning (for example, changes “Credit Card” into “Charge Card”). Moreover, ID-value assessment system 100 associates an ontology concept with another ontology concept. When the processing of step S141 is completed, the ID-value assessment system 100 advances the processing to step S105.

Regarding Processing of S105

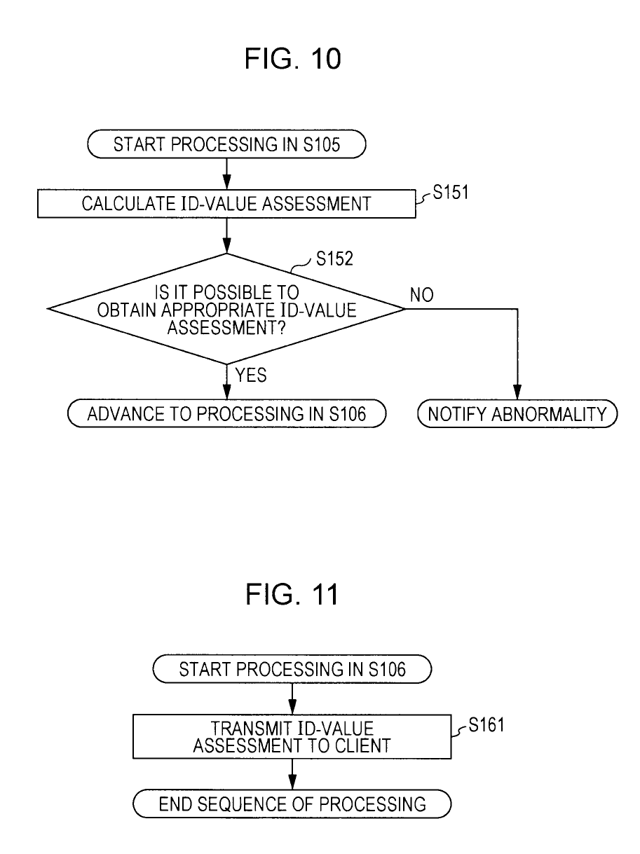

Next, refer to FIG. 10. As shown in FIG. 10, when the processing of step S105 is started, the ID-value assessment system 100 calculates the assessment by using the ID-value assessment function which is provided in advance (S151). Subsequently, the ID-value assessment system 100 determines whether or not the assessment calculated in step S151 is an appropriate value (S152). If the assessment calculated in step S151 is appropriate, the ID-value assessment system 100 advances the processing to step S106. In contrast if the assessment calculated in step S151 is not appropriate, the ID-value assessment system 100 notifies abnormality to the client of the assessment (the ad delivery system 104).

Regarding Processing of S106

Next, refer to FIG. 11. As shown in FIG. 11, when the processing of step S106 is started, the ID-value assessment system 100 transmits the assessment to the client of the assessment (S161). For example, when receiving the request of the assessment from the ad delivery system 104, the ID-value assessment system 100 transmits the assessment, which is calculated in step S105, to the ad delivery system 104. When the transmission of the assessment is completed, the ID-value assessment system 100 ends a series of processing relevant to the calculation of the assessment.

Hitherto, the operations of the ID-value assessment system 100 relevant to the assessment calculation have been described. Next, the operations of the ID-value assessment system 100 relevant to the generation of the ID-value assessment function will be described.

1-5-2. Flow of Function Generation

Here, refer to FIG. 12. As shown in FIG. 12, the ID-value assessment system 100 first collects the learning sample data (S201). The learning sample data includes, as shown in FIG. 13, the user attribute information, the ad insertion site attribute information, the advertiser site attribute information, the general information, the user-action history, and the like. A method of collecting the user attribute information, the ad insertion site attribute information, and the advertiser site attribute information is the same as a method of collecting the respective pieces of the attribute information executed when calculating the assessment. Further, the user-action history is acquired from the ad delivery system 104, the ad insertion site provision system 103, the user terminal 102, and the like.

The learning sample data exemplified in FIG. 13 includes, as the user attribute information, “U(1): age”, “U(2): gender”, and “U(3): number of purchase events”, and includes, as the ad insertion site attribute information, “A(1): type of accessed site” and “A(2): degree of popularity”. Moreover, the learning sample data also includes, as the advertiser site attribute information, “B(1): advertisement product” and “B(2): price”, and includes, as the general information, “G(1): year/month”, and includes, as the user-action history, “C(1): purchase performance” and “C(2): recommendation in blog”. For example, by using the learning sample data, it is possible to generate the ID-value assessment function of outputting the degree of expectation in purchase in response to the input of the attribute information. Likewise, by using the learning sample data, it is possible to generate the ID-value assessment function of outputting the degree of expectation of recommendation in blog in response to the input of the attribute information.

Refer to FIG. 12 again. The ID-value assessment system 100, which collected the learning sample data in step S201, shapes the data format of the learning sample data, which is collected in step S201, such that the data format is appropriate to the input format of the ID-value assessment function (S202). For example, the ID-value assessment system 100 changes a word expression into another word expression which is substantially the same but has a different combination of characters (for example, changes “CreditCard” into “Credit Card”). Further, the ID-value assessment system 100 changes a word expression into another word expression which has the same meaning (for example, changes “Credit Card” into “Charge Card”). Moreover, ID-value assessment system 100 associates an ontology concept with another ontology concept.

Subsequently, the ID-value assessment system 100 stores the learning sample data which is shaped in step S202 (S203). Subsequently, the ID-value assessment system 100 generates the ID-value assessment function by using the learning sample data which is stored in step S203 (S204). At this time, the ID-value assessment system 100 generates the ID-value assessment function capable of outputting the assessment corresponding to the assessment item in response to the input of the attribute information through the machine learning using the learning sample data. When the generation of the ID-value assessment function is completed, the ID-value assessment system 100 ends a series of processing relevant to the generation of the ID-value assessment function.

Hitherto, the operations of the ID-value assessment system 100 relevant to the generation of the ID-value assessment function have been described.

1-6. Processing Sequence of Ad Provision System 10

Next, referring to FIGS. 15 and 16, a specific processing sequence of the ad provision system 10 will be described. FIGS. 15 and 16 are explanatory diagrams illustrating the processing sequences executed in the ad provision system 10 according to the embodiment.

In addition, the processing sequence described herein relates to a method of using the ID-value assessment system 100 in determination of the advertisement fee in an affiliate program. In particular, the processing sequence relate to a structure in which the assessment client (ad delivery system 104) determines the advertisement fee in real time in the affiliate program. The advertisement fee depends on a total of advertising costs and an advertisement period. However, the advertisement fee, which is determined in the ad provision system 10, can be determined in accordance with the assessment which is calculated by the ID-value assessment system 100. Further, the assessment is the degree of expectation in purchase when emphasis is placed on short-term user action, and is the assessment relevant to the degree of royalty or association when emphasis is placed on long-term user action.

1-6-1. Specific Example 1

First, refer to FIG. 15. As shown in FIG. 15, first, the user (user terminal 102) accesses the ad insertion site (ad insertion site provision system 103) (S401). When receiving the access from the user, the ad insertion site provision system 103 transmits data of a home page (the ad insertion site) to the user terminal 102 (S402). Subsequently, when the user clicks the advertisement inserted in the ad insertion site, the user ID, the ad insertion site ID, and the advertiser site ID are provided from the user terminal 102 to the ad delivery system 104 (S403). The user ID, the ad insertion site ID, and the advertiser site ID, which are provided from the user terminal 102, are retained by the ad delivery system 104.

Subsequently, the ad delivery system 104 changes the access destination of the user terminal 102 from the ad insertion site to the advertiser site (S404). As a result, the access destination of the user terminal 102 is changed from the ad insertion site to the advertiser site (S405). Further, the ad delivery system 104 transmits the user ID which is provided from the user terminal 102, the ad insertion site ID, and the advertiser site ID to the ID-value assessment system 100, and makes a request to calculate the assessment, which represents the values of the user, corresponding to the user ID (S406). When receiving the request, the ID-value assessment system 100 collects the user attribute information, the ad insertion site attribute information, and the advertiser site attribute information corresponding to the user ID, the ad insertion site ID, and the advertiser site ID.

For example, the ID-value assessment system 100 transmits the user ID, the ad insertion site ID, and the advertiser site ID to the attribute management system 106, and makes a request to provide the user attribute information, the ad insertion site attribute information, and the advertiser site attribute information corresponding to these IDs (S407). In addition, the ID-value assessment system 100 may be configured to request attribute management systems 106, which are different from each other, to provide the respective pieces of the attribute information. The attribute management system 106, which received the request, transmits the user attribute information, the ad insertion site attribute information, and the advertiser site attribute information to the ID-value assessment system 100 (S408). When receiving the respective pieces of attribute information, the ID-value assessment system 100 calculates the assessment, which represents the values of the user, on the basis of the received user attribute information, ad insertion site attribute information, advertiser site attribute information, and general information.

Then, the ID-value assessment system 100 transmits the calculated assessment to the ad delivery system 104 (S409). The ad delivery system 104, which received the assessment, calculates the fee to be paid to the advertisement publisher on the basis of the received assessment, and notifies the calculated fee to the advertiser site provision system 105 (S410). Moreover, the ad delivery system 104 notifies the calculated fee to the ad insertion site provision system 103 (S411). When the fee is notified to the advertiser site provision system 105 and the ad insertion site provision system 103, the fee is paid from the advertiser site provision system 105 to the ad insertion site provision system 103 (S412).

Hitherto, the specific example of the processing sequence of the ad provision system 10 has been described. In addition, the dashed line in FIG. 15 is a part relating to the processing of the ID-value assessment system 100.

1-6-2. Specific Example 2

First, refer to FIG. 16. As shown in FIG. 16, first, the user (user terminal 102) accesses the ad insertion site (ad insertion site provision system 103) (S501). When receiving the access from the user, the ad insertion site provision system 103 transmits data of a home page (the ad insertion site) to the user terminal 102 (S502). Subsequently, when the user clicks the advertisement inserted in the ad insertion site, the user ID, the ad insertion site ID, and the advertiser site ID are provided from the user terminal 102 to the ad delivery system 104 (S503). The user ID, the ad insertion site ID, and the advertiser site ID, which are provided from the user terminal 102, are retained by the ad delivery system 104.

Subsequently, the ad delivery system 104 changes the access destination of the user terminal 102 from the ad insertion site to the advertiser site (S504). As a result, the access destination of the user terminal 102 is changed from the ad insertion site to the advertiser site (S505). Further, the ad delivery system 104 transmits the user ID which is provided from the user terminal 102, the ad insertion site ID, and the advertiser site ID to the ID-value assessment system 100, and makes a request to calculate the assessment, which represents the values of the user, corresponding to the user ID (S506). When receiving the request, the ID-value assessment system 100 collects the user attribute information, the ad insertion site attribute information, and the advertiser site attribute information corresponding to the user ID, the ad insertion site ID, and the advertiser site ID.

For example, the ID-value assessment system 100 transmits the ad insertion site ID and the advertiser site ID to the attribute management system 106, and makes a request to provide the ad insertion site attribute information and the advertiser site attribute information corresponding to these IDs (S507). In addition, the ID-value assessment system 100 may be configured to request attribute management systems 106, which are different from each other, to provide the respective pieces of the attribute information. The attribute management system 106, which received the request, transmits the ad insertion site attribute information and the advertiser site attribute information to the ID-value assessment system 100 (S508).

Further, the ID-value assessment system 100 executes processing of interchanging the attribute information by using the user ID on the basis of the ID-related technique such as the Open ID or SAML. For example, the ID-value assessment system 100 receives the information on the user from the ad delivery system 104, and acquires URL (Uniform Resource Locator) of the attribute management system 106 through Discovery. Subsequently, the ID-value assessment system 100 exchanges common keys with the attribute management system 106 (S509). The common key is for checking whether or not the respective pieces of the attribute information acquired from the attribute management system 106 are legitimate. This step may be performed after the ID-value assessment system 100 acquires the attribute information from the attribute management system 106.

Subsequently, the ID-value assessment system 100 requests the user terminal 102 to transmit the user attribute information to the attribute management system 106 (S510). The user terminal 102, which received the request, requests the attribute management system 106 to transmit the user attribute information (S511). The attribute management system 106, which received the request, transmits the user attribute information to the user terminal 102 (S512). The user terminal 102, which received the user attribute information, transmits the received user attribute information to the ID-value assessment system 100 (S513). When receiving the respective pieces of attribute information, the ID-value assessment system 100 calculates the assessment, which represents the values of the user, on the basis of the received user attribute information, ad insertion site attribute information, advertiser site attribute information, and general information.

Then, the ID-value assessment system 100 transmits the calculated assessment to the ad delivery system 104 (S514). The ad delivery system 104, which received the assessment, calculates the fee to be paid to the advertisement publisher on the basis of the received assessment, and notifies the calculated fee to the advertiser site provision system 105 (S515). Moreover, the ad delivery system 104 notifies the calculated fee to the ad insertion site provision system 103 (S516). When the fee is notified to the advertiser site provision system 105 and the ad insertion site provision system 103, the fee is paid from the advertiser site provision system 105 to the ad insertion site provision system 103 (S517).

Hitherto, the specific example of the processing sequence of the ad provision system 10 has been described. In addition, the dashed line in FIG. 16 is a part relating to the processing of the ID-value assessment system 100.

1-7. Hardware Configuration

Functions of the respective components belonging to the respective systems and the user terminal can be implemented by using, for example, a hardware configuration of an information processing apparatus shown in FIG. 17. That is, the functions of the respective components are implemented by controlling the hardware shown in FIG. 17 through a computer program. In addition, the form of the hardware is arbitrary, and includes, for example, a personal computer, a mobile phone, a portable information terminal such as a PHS or a PDA, a game machine, and various home information appliances. Here, the PHS is an abbreviation for Personal Handy-phone System. Further, the PDA is an abbreviation for Personal Digital Assistant.

As shown in FIG. 17, the hardware mainly includes a CPU 902, a ROM 904, a RAM 906, a host bus 908, and a bridge 910. Moreover, this hardware includes an external bus 912, an interface 914, an input section 916, an output section 918, a storage section 920, a drive 922, a connection port 924, and a communication section 926. Here, the CPU is an abbreviation for Central Processing Unit. Further, the ROM is an abbreviation for Read Only Memory. Furthermore, the RAM is an abbreviation for Random Access Memory.

The CPU 902 functions as an arithmetic processing section or a control section, for example, and controls an entire operation or a part of the operation of each component based on various programs recorded on the ROM 904, the RAM 906, the storage section 920, or a removal recording medium 928. The ROM 904 is a section for storing, for example, a program to be loaded on the CPU 902 or data or the like used in an arithmetic operation. The RAM 906 temporarily or perpetually stores, for example, the program to be loaded on the CPU 902 or various parameters or the like appropriately changed in execution of the program.

These components are connected to each other by, for example, the host bus 908 capable of performing high-speed data transmission. For its part, the host bus 908 is connected through the bridge 910 to the external bus 912 of which the data transmission speed is relatively low, for example. Further, the input section 916 is, for example, a mouse, a keyboard, a touch panel, a button, a switch, or a lever. Furthermore, the input section 916 may be a remote control which can transmit a control signal by using an infrared ray or other radio waves.

The output section 918 is, for example, a display device such as a CRT, an LCD, a PDP or an ELD, an audio output device such as a speaker or headphones, a printer, a mobile phone, or a facsimile, which can visually or auditorily notify a user of acquired information. Here, the CRT is an abbreviation for Cathode Ray Tube. Further, the LCD is an abbreviation for Liquid Crystal Display. Furthermore, the PDP is an abbreviation for Plasma Display Panel. Moreover, the ELD is an abbreviation for Electro-Luminescence Display.

The storage section 920 is a device for storing various data. The storage section 920 is, for example, a magnetic storage device such as a hard disk drive (HDD), a semiconductor storage device, an optical storage device, or a magneto-optical storage device. Here, the HDD is an abbreviation for Hard Disk Drive.

The drive 922 is a device that reads information recorded on the removal recording medium 928 such as a magnetic disk, an optical disk, a magneto-optical disk, or a semiconductor memory, or writes information in the removal recording medium 928. The removal recording medium 928 is, for example, a DVD medium, a Blu-ray medium, an HD-DVD medium, various types of semiconductor storage media, or the like. It is apparent that the removal recording medium 928 may be, for example, an IC card on which a non-contact IC chip is mounted or an electronic device. Here, the IC is an abbreviation for Integrated Circuit.

The connection port 924 is a port such as an USB port, an IEEE1394 port, a SCSI, an RS-232C port, or a port for connecting an externally connected device 930 such as an optical audio terminal. The externally connected device 930 is, for example, a printer, a mobile music player, a digital camera, a digital video camera, or an IC recorder. Here, the USB is an abbreviation for Universal Serial Bus. Further, the SCSI is an abbreviation for Small Computer System Interface.

The communication section 926 is a communication device to be connected to a network 932, and is, for example, a communication card for a wired or wireless LAN, Bluetooth (a registered trademark), or WUSB, an optical communication router, an ADSL router, or various communication modems. The network 932 connected to the communication section 926 is configured from a wire-connected or wirelessly connected network, and is the Internet, a home-use LAN, infrared communication, visible light communication, broadcasting, or satellite communication, for example. Here, the LAN is an abbreviation for Local Area Network. Further, the WUSB is an abbreviation for Wireless USB. Furthermore, the ADSL is an abbreviation for Asymmetric Digital Subscriber Line.

### 2. Summary

Finally, the technical contents according to the embodiment of the disclosure will be briefly summarized. The technical contents stated herein can be applied to various information processing apparatuses such as a personal computer, a mobile phone, a portable game machine, a portable information terminal, an information appliance, and a car navigation system.

The functional configuration of the information processing apparatus described above can be expressed as follows. The information processing apparatus has the assessment calculation section and the assessment output section described below. The assessment calculation section calculates a value assessment of a user to be assessed by using an assessment function of outputting the value assessment, which represents the values of the corresponding user, in response to inputs of user attribute information representing an attribute of the user and service attribute information representing an attribute of a service and general information. Further, the assessment output section outputs a user ID of the user to be assessed and the value assessment of the corresponding user, which is calculated by the assessment calculation section, in association with each other.

In addition, the general information includes information on a time and date, a season, special events (a bargain, a TV program, a festival, an incident, and the like), a venue of an event, and the like. That is, the general information is information which represents a time and date, a social situation, or the like. Further, the general information is information independent of the attribute of the user or the service, and is information as an input of the ID-value assessment function.

In such a configuration, the information processing apparatus has the assessment calculation section, and thus it is possible to calculate the value of the user in consideration of all the attributes of the user and the service. Further, the information processing apparatus has the assessment output section, and thus it is possible to value the user ID. As described above, considering the relationship between the user and the service, a degree of influence of the individual users on a certain service or a degree of influence of a certain user to other users through a service can be expressed by an indicator called the value assessment attached to the user ID.

For example, the value of the user, in which a relationship among a provision service of a product and an advertisement service of the product, and the user is considered, directly leads to a probability that the user views the advertisement and thus purchases the product, a probability that a friend of the user purchases the product, or the like. If it is possible to know the probability that the user purchases the product, for example, it is possible to build a structure in which a fee corresponding to the probability is paid to the advertisement service provider. Consequently, even in the case where the user does not purchase the product in practice, or even in the case where it is unknown which advertisement service makes the user purchase the product, it is possible to build the structure in which the fee is paid to the advertisement service provider.

### NOTE

The ID-value assessment system 100 is an example of the ID-value assessment device. The ID-value assessment section 115 is an example of the assessment calculation section and the assessment output section. The ID-value assessment function generation section 117 is an example of the assessment function generation section. The information collecting section 112 is an example of the service attribute information acquisition section. The ad insertion site provision system 103 is an example of the ad delivery server. The ad delivery system 104 is an example of the ad provision server.

The present disclosure contains subject matter related to that disclosed in Japanese Priority Patent Application JP 2010-188127 filed in the Japan Patent Office on Aug. 25, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An ID-value assessment device comprising:
an assessment calculation section that calculates a value assessment of a user to be assessed by using an assessment function of outputting the value assessment, which represents values of the corresponding user, in response to inputs of user attribute information representing an attribute of the user and service attribute information representing an attribute of a service and general information; and
an assessment output section that outputs a user ID of the user to be assessed and the value assessment of the corresponding user, which is calculated by the assessment calculation section, in association with each other.

2. The ID-value assessment device according to claim 1, further comprising an assessment function generation section that generates the assessment function through machine learning based on a set of user attribute information, service attribute information, general information, and a user-action history, which are prepared in advance, as learning data.

3. The ID-value assessment device according to claim 2, further comprising a service attribute information acquisition section that analyzes information, which is written in a service provision site for providing the service, and acquires the service attribute information of the service which is provided by the corresponding service provision site.

4. The ID-value assessment device according to claim 3, wherein the service attribute information acquisition section acquires the service attribute information by performing prescribed language processing on the information which is written in the service provision site.

5. The ID-value assessment device according to claim 1,
wherein the service includes a service for providing an advertisement to the user, and
wherein when the user performs an operation relevant to the advertisement, the assessment calculation section sets the corresponding user as the user to be assessed and calculates the value assessment.

6. The ID-value assessment device according to claim 1,
wherein the assessment calculation section sets a set of users, who visit the service provision site for providing the service, as a set of users to be assessed, calculates the value assessments of the respective users included in the corresponding set, and calculates a value-set assessment by adding up the corresponding value assessments of the respective users.
wherein the assessment output section associates an ID of the service provision site with the value-set assessment, which is calculated by the assessment calculation section, and outputs the ID and the value-set assessment.

7. The ID-value assessment device according to claim 1, further comprising a data shaping section that converts a representation of the service attribute information, which is input to the assessment function, into a representation thereof which can be input to the corresponding assessment function.

8. An ID-value assessment system comprising:
an ID-value assessment device that has
an assessment calculation section which calculates a value assessment of a user to be assessed by using an assessment function of outputting the value assessment, which represents values of the corresponding user, in response to inputs of user attribute information representing an attribute of the user and service attribute information representing an attribute of a service and general information, and
an assessment output section which outputs a user ID of the user to be assessed and the value assessment of the corresponding user, which is calculated by the assessment calculation section, in association with each other;
an ad delivery server that provides a service of delivering advertisement to the user; and
an ad provision server that provides a content of the advertisement to the ad delivery server,
wherein when the user performs an operation relevant to the advertisement which is delivered by the ad delivery server, the ad delivery server requests the ID-value assessment device to assess the corresponding user,
wherein the ID-value assessment device causes the assessment calculation section to calculate the value assessment of the user who is a target of the request issued from the ad delivery server, and causes the assessment output section to associate the value assessment of the corresponding user with the user ID of the corresponding user and outputs the value assessment and the user ID to the ad delivery server, and
wherein the ad delivery server provides the value assessment of the user, which is acquired from the ID-value assessment device, together with the user ID associated with the corresponding value assessment, to the ad provision server.

9. An ID-value assessment method comprising:
calculating a value assessment of a user to be assessed by using an assessment function of outputting the value assessment, which represents values of the corresponding user, in response to inputs of user attribute information representing an attribute of the user and service attribute information representing an attribute of a service and general information; and
outputting a user ID of the user to be assessed and the value assessment of the corresponding user, which is calculated by the calculating of the assessment, in association with each other.
